(19) United States
(12) Patent Application Publication
(10) Pub. No.: US 2015/0246401 A1
(43) Pub. Date: Sep. 3, 2015

(54) Cutting tool mounted for rotary drive

(71) Applicant: Gühring KG, Albstadt (DE)

(72) Inventor: Gilbert KLEINER, Inzigkofen (DE)

(21) Appl. No.: 14/658,680

(22) Filed: Mar. 16, 2015

Related U.S. Application Data
(63) Continuation of application No. PCT/DE2013/000517, filed on Sep. 12, 2013.

(30) Foreign Application Priority Data
Sep. 18, 2012 (DE) 10 2012 216 655.6

(51) Int. Cl. B23D 77/00

(52) U.S. Cl. CPC B23D 77/006; B23D 2277/60

(57) ABSTRACT

A distributor screw (1) and a cutting tool are created, which form an annular space between a shank (30A, 30B) of the distributor screw (1) and a bore into which the distributor screw (1) is introduced. In the annular space, coolant/lubricant fed via axial grooves (10) from a central coolant/lubricant supply duct is distributed uniformly, in order to be diverted radially in all directions, i.e. through 360°, at a distributor head (40) of the distributor screw (1), and to be dispensed uniformly in the direction of the tool cutting lips.

### BACKGROUND OF THE INVENTION

1. Field of the Invention

The present invention relates to a cutting tool, in particular to a cutting tool mounted for rotary drive with a coolant and lubricant supply.

2. Description of the Related Art

Such cutting tools are known in prior art. For example, DE 10 2010 046 044 A1, which is regarded as most obvious prior art, discloses a reamer as a cutting tool mounted for rotary drive according to the preamble to claim 1. This reamer exhibits an axially centrally running coolant/lubricant supply duct, as well as at least one cutting edge on the periphery. The axially centrally running coolant/lubricant supply duct is sealed with a coolant screw. The coolant screw exhibits two leveled areas on the screw shank, by which the coolant/lubricant can flow toward the face end of the reamer. At least one (radially running) groove, but usually several grooves, leading to the corresponding cutting edges are milled into the reamer at the face of the reamer. The screw head sitting at the face end of the reamer serves as a cover, which together with the groove forms a radially running duct, which diverts the coolant/lubricant out of the axially centrally running coolant/lubricant supply duct. Coolant/lubricant is to be applied to the periphery of the reamer in proximity to the cutting edge(s) by way of the radially running coolant/lubricant duct, thereby cooling and lubricating the cutting edge(s) and work piece.

### SUMMARY OF THE INVENTION

As was revealed in simulations and tests, however, the problem that arises for a configuration according to this prior art is that the coolant/lubricant is not distributed over the entire periphery uniformly enough. In extreme cases, this might lead to several cutting edges in the cutting tool not being cooled, and others being excessively cooled. This results in an elevated wear on the tools on the one hand, and, in particular during high-precision machining, less of an ability to control the thermal expansion of the tool and work piece on the other, thereby elevating the production tolerances.

Therefore, the object of the invention is to improve prior art with an eye toward achieving a uniform cooling of the work piece.

This object is achieved with cutting tools as described herein.

The invention provides a cutting tool, in particular a reamer, with a distributor screw that exhibits a flow section having a cross section with a lower diameter in the flowing direction of the coolant and/or lubricant in the area between the flight lands and head, which forms an axially extending annular space around the entire flow section with an axial bore in the cutting part of the tool.

The coolant/lubricant flowing in through axial grooves between the flight lands can be distributed In this annular space, and drain away uniformly on all sides of the cutting tool. As a result, even given a smaller passage for coolant/lubricant than in prior art through the axial grooves along the coolant screw, the coolant/lubricant can be sufficiently distributed in the flow section, so that enough coolant/lubricant is available over 360° of the entire periphery. Several axial grooves are optimally formed in the thread between the distributor screw and cutting tool. However, as a result of the improved distribution of the coolant/lubricant in the annular space, the coolant/lubricant can in principle be distributed in all cutting edges homogeneously enough even through a single axial groove or a comparable opening with a low cross sectional area, for example a leveled portion of a male thread of a distributor screw between the axially centrally running coolant/lubricant supply duct and the annular space.

Even though reference is made above to a “distributor screw” and “flight lands”, let it be noted that the connection between the axially central coolant/lubricant supply duct and the screw head and shank of the distributor screw above the thread of the distributor screw which together with the coolant/lubricant supply duct forms the annular space according to the invention can also be established without a screw thread, for example through procedures such as soldering, adhesive bonding or injection. The only critical factor is the ability to guide coolant/lubricant from the coolant/lubricant supply duct by the attachment (the “flight lands”) of the distributor screw and into the annular space, and there divert it in a radial direction along the face of the cutting tool and allow it to exit through a gap between the distributor screw and face of the cutting tool.

Another advantage to the invention apart from that of a uniform coolant/lubricant distribution is that no additional radial grooves have to be milled into the face of the cutting tool. The bottom side of the screw head can also have a conventional flat design, without exhibiting any grooves.

In a preferred embodiment, the annular space is cylindrical. A cylindrical annular space can be easily fabricated by having the distributor screw exhibit a shank that has a lower diameter than the nominal thread diameter of the distributor screw, similarly to an expansion screw, and/or by having the face end of the coolant/lubricant supply duct exhibit a larger diameter than the nominal thread diameter of the distributor screw. Accordingly, in cases where no screw connection is used, the cylindrical annular space can be generated by a bore in the cutting tool, which forms the coolant/lubricant supply duct, and a shank of the distributor screw between the seat of the distributor screw in the coolant/lubricant supply duct and the head of the distributor screw. Simply boring a hole in the cutting tool and turning the shank of the distributor screw only involve very minor requirements from a manufacturing standpoint, and can be done with a high precision at a comparatively low cost.

In another preferred embodiment, the annular space tapers in the flowing direction. As the coolant/lubricant enters into the annular space through the axially running coolant/lubricant supply duct and axial grooves, it is slightly depressurized during entry into an annular space that tapers in the flowing direction, and accelerated again as it continues to move through the annular space, as a result of which it becomes more uniformly distributed in the flow section. At the outlet from the flow section and during diversion through the head of the distributor screw, the provided gap is the smallest, and the flow rate thus the highest. As a result, the coolant/lubricant is optimally convened toward the periphery of the cutting tool, and hence to the cutting edges of the cutting part. For example, the taper can measure 1° to 5°, preferably 3° opposite the axial direction of the cutting part.

The distributor is preferably attached in the coolant/lubricant supply duct in such a way that the distributor head exhibits a predefined distance from the face end of the coolant/lubricant supply duct. This firmly sets the outlet gap for the coolant/lubricant. For example, the distance can be defined by way of a stop that the screwed in distributor screw hits. In principle, such a stop can also be given a variable design, e.g., so that varyingly dense coolants/lubricants can be optimally used; however, a fixed stop is preferred, wherein the thickness of the outlet gap can be adjusted via the length of the distributor screw.

It is especially preferred that the side of the distributor screw remote from the head exhibit an outer cone, which abuts against an inner cone formed in front of the threaded bore in the flowing direction of the coolant/lubricant in order to center and fix the axial position of the distributor screw relative to the cutting part. This inner cone then serves as the stop. The advantage to this embodiment is that two cones (inner and outer cone) achieve a linear or surface contact over the entire periphery, even given existing production tolerances, e.g., differing cone angles. This prevents the screwed in distributor screw from tilting in the cutting part, so that the outlet gap remains the same size throughout. This prevents coolant/lubricant from exiting in unequal amounts in different directions. As a consequence, all cutting edges of the cutting tool are uniformly cooled.

It is further preferred that the flow surface on the back side of the head lie at a defined axial distance to the face of the cutting part. Just as in the most obvious prior art outlined above, the invention does also allow the incorporation of additional grooves either into the bottom side of the screw head or into the face of the cutting part, but this is not necessary if instead a defined distance or outlet gap is present all around between the back side of the screw head and face of the cutting tool. The mentioned outlet gap can be uniformly configured all around, and cover the face of the cutting tool like an umbrella or mushroom. In addition, the outlet gap must not be shaped in such a way that the bottom side of the distributor screw runs parallel to the front surface of the cutting tool, but rather can also bend toward or away from the latter, so that the outlet gap influences the exit of coolant/lubricant toward the cutting edges not just because of the defined axial distance between these surfaces, but also due to the inclination of the surfaces relative to each other. For example, an expansion can lead to an elevated acceleration of the coolant/lubricant, which then is guided similarly to a Laval nozzle (except for the diversion at the distributor head). If the bottom side of the distributor head and front surface of the cutting tool converge, this can have the effect of lengthening the tapering annular space discussed above in terms of flow. The described uniform configuration yields more easily fabricated, smooth surfaces on the distributor screw and on the cutting tool, and a more uniform distribution of coolant/lubricant is also achieved.

However, if a stricter control of the coolant/lubricant flow is to be achieved for specific reasons, it is also possible to provide grooves between the distributor screw and front surface of the cutting part, similarly to known prior art, which can be furnished in the front surface of the cutting part, on the rear side of the distributor head or in both parts. In this case as well, the annular space according to the invention provided “upstream” from the grooves results in a uniform supply of coolant/lubricant to all cutting edges, even given a low number of axial grooves. This effectively avoids the disadvantages to prior art mentioned at the outset.

It is especially preferred that the distributor head encompass a screw drive, for example a hexagon socket or hexagon head. If the distributor head is screwed into the cutting part, as described in the following embodiments, the distributor head must be provided with a screw drive.

### BRIEF DESCRIPTION OF THE DRAWINGS

The invention will be described below based on embodiments, drawing reference to the attached figures. The figures show:

FIG. 1 an isometric view of a reamer as an example for a cutting tool from prior art;

FIG. 2 a section through the reamer according to FIG. 1;

FIG. 3 a top view of a coolant screw according to prior art;

FIGS. 4 and 5 two sections of the screw according to FIG. 3 lying perpendicular to each other;

FIG. 6 is an isometric view of a distributor screw according to the invention;

FIG. 7 is a front-end cutout of a cutting tool according to a preferred embodiment of the invention, into which the distributor screw according to FIG. 6 can be screwed;

FIG. 8 is a top view of the distributor screw according to the preferred embodiment of the invention;

FIG. 9 is a side view of the distributor screw according to the preferred embodiment of the invention;

FIG. 10 is a section C-C through the distributor screw shown on FIGS. 8 and 9;

FIG. 11 is a section D-D through the distributor screw shown on FIGS. 8 and 9;

FIG. 12 is a top view of the screw drive of the distributor screw according to the preferred embodiment of the invention, i.e., a top view of the distributor screw from the side lying opposite the top view from FIG. 8;

FIG. 13 is a schematic side view of a cutting tool according to the invention (without visible cutting edges); and

FIG. 14 is a detail of the distributor screw shown on FIG. 6.

### DETAILED DESCRIPTION OF THE INVENTION

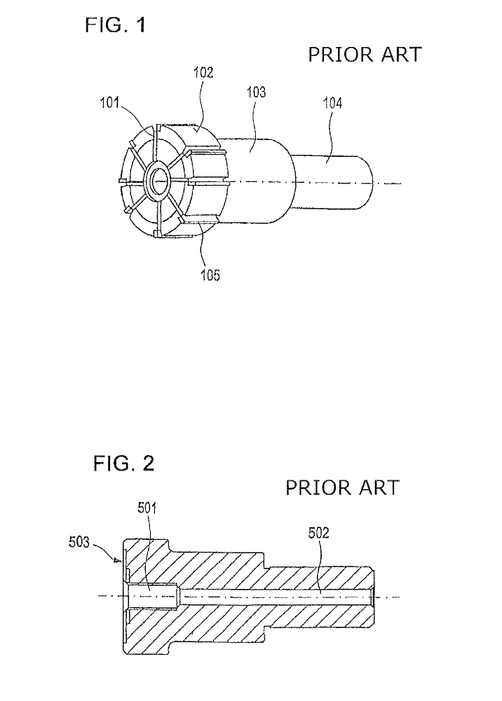

FIG. 1 presents a view of a reamer as an example for a cutting tool from prior art in an isometric projection. Readily visible here are the grooves 101, the free surfaces 102, which are used to discharge the chips and excess coolant/lubricant (hereinafter also referred to as “coolant” for short), and the cutting edges 105. The reamer can be accommodated in a tool chuck at the shank sections 103, 104.

FIG. 2 presents a section through the reamer according to FIG. 1. Coolant flows from right to left through the axially running coolant/lubricant supply channel 502 into the cooling duct 501 with a large diameter and a thread into which a coolant screw can be screwed. Readily visible is the groove 503, which corresponds to the groove 101 on FIG. 1.

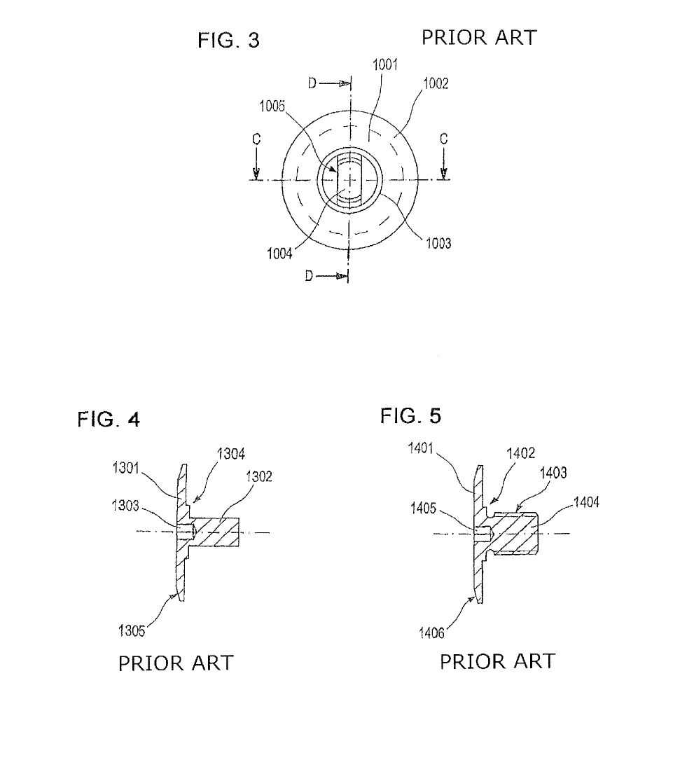

A coolant screw according to FIGS. 3 to 5 is screwed into the reamer according to FIG. 1, and serves as a distributor. FIGS. 4 and 5 are two sections C-C (FIG. 4) and D-D (FIG. 5) through the screw according to FIG. 3 that lie perpendicular to each other. The screw according to FIG. 3 encompasses a screw head 1001 with a leveled area 1002, a step 1003, a screw shank 1004 and a leveled area 1005. As evident from the sections on FIGS. 4 and 5 lying perpendicular to each other, the coolant screw according to prior art exhibits a shank 1404, which consists of a thread 1403 that was leveled on two sides 1005, 1302, 1404. Coolant can flow through the axially running coolant/lubricant supply duct on the leveled sides 1005 on FIG. 3, and is diverted at the distributor head 1301, 1401, in order to be guided toward the cutting edges via the grooves 101, 503 (see FIGS. 1 and 2). Finally, the coolant screw encompasses a screw drive 1303, 1405, which here is designed as a hexagon socket, as well as a leveled area 1305, 1406 at the edge of the coolant screw to provide space, e.g., for chips.

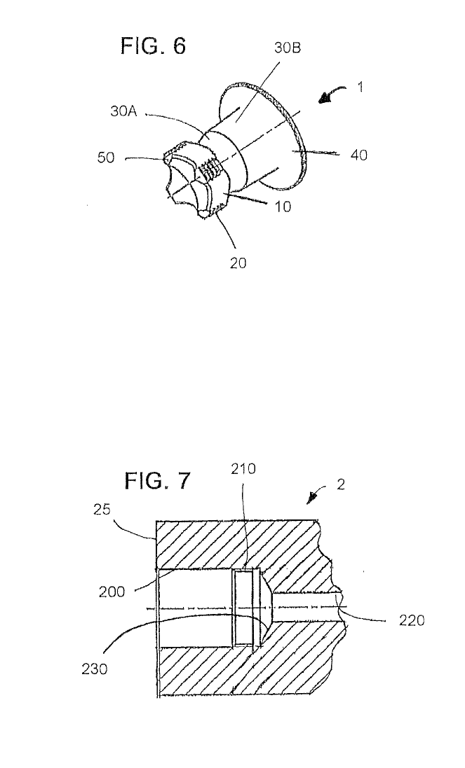

FIG. 6 presents an isometric view of a distributor screw 1 according to the invention. In comparison to prior art, several—four on the figure—axial grooves 10 are created between flight lands 20 on the one hand, so as to ensure a better distribution of introduced coolant from the very outset already. The axial grooves and flight lands are also referred to jointly as the “thread” of the distributor screw. The thread of the distributor screw is adjoined by the (here two-part) shank 30 with sections 30A, 30B, which serves as a flow section. A larger, semitoroidal space is here created at the shank section 30A in conjunction with the female thread in the cutting tool 2 (depicted on FIG. 7 and described in more detail below), into which coolant flows through the axial grooves 10, and in which it depressurizes through expansion. It then continues to flow through the annular space formed by the outer surface of the shank section 30B and female thread of the cutting tool. Since the diameter of the distributor screw 1 becomes larger along the outer surface of the shank section 30B toward the distributor head 40 in this embodiment, the space for the coolant between the distributor screw 1 and cutting tool tapers or narrows, so that coolant in the annular space is accelerated, and simultaneously is uniformly distributed in the peripheral direction in the annular space. As a result, the coolant is prepared in such a way that it can uniformly exit over 360° in all directions on the periphery. The coolant is diverted at the distributor head and guided radially to the side of the cutting tool, and hence toward the cutting edges. The side of the distributor screw 1 lying opposite the distributor head 40 exhibits an outer cone 50, which interacts with an inner cone 230 in the cutting tool 2 described below based on FIG. 7, and is more readily visible on FIGS. 9 and 10.

FIG. 7 presents a front-end cutout of the cutting tool 2 according to the preferred embodiment of the invention, into which the distributor screw 1 can be screwed. Just as the tool according to prior art, the cutting tool 2 according to the invention encompasses cutting edges similar to cutting edges 105, even though not shown in detail. Alternatively, the invention can be also be used for a tool with geometrically indeterminate cutting edges, such as a grinding tool. In such a tool, having the coolant be distributed as uniformly as possible is comparably important as for the reamer shown as an example.

In comparison to the cutting tool according to FIG. 2, in which the thread 501 is cut from the front surface, the cutting tool 2 according to the invention only uses a female thread 201 on a comparably short piece of a bore 200, into which the distributor screw 1 can be screwed. The bore 200 and female thread 210 align with a centrally running coolant/lubricant supply duct 220, from which the coolant is introduced. An inner cone 230 adjoins the female thread 210 opposite the direction of coolant flow, i.e., away from the face 2S of the cutting tool 2, and connects the bore 200 with the coolant/lubricant supply duct 220.

The distributor screw 1 is introduced into the bore 200 of the cutting tool 2 described above, and screwed into the thread section 210. The front outer cone 50 of the distributor screw 1 here hits the inner cone 230 in such a way as to secure the distributor screw in this location it is being screwed in. As a consequence, the outlet gap between the distributor head 40 and the face 2S of the cutting tool 2 remote from the shank portion that forms an end section of the cutting tool is determined by the difference between the length of the distributor screw 1 from the outer cone 50 of the distributor screw 1 to the distributor head 40 and the length between the face 2S and inner cone 230 of the cutting tool. In a preferred embodiment, the dimensions of the gap can range between 0.4 mm and 0.6 mm.

In an assembled state, the shank sections 30A, 30B of the distributor screw 1 and the bore 200 border the annular space, in which the coolant is uniformly distributed. Even though not depicted in the embodiment, the female thread 210 can also extend up to the face 2S; in this case, however, assembly is made somewhat more complicated by the longer screwing processes while inserting the distributor screw 1 into the cutting tool 2. In addition, coolant distribution along the smooth bore walls of the bore 200 can be improved. In particular when using an aerosol as a minimum quantity lubricant during so-called MMS lubrication, a thread longer than required might contribute to an undesired demixing of the coolant/lubricant.

In the assembled state not shown here, the outer cone surface 50 of the distributor screw 1 hits the inner cone surface 230 of the cutting tool 2 according to the embodiment. This ideally yields a surface contact, but at the very least a linear contact between the distributor screw 1 and cutting tool 2 on the cone surfaces. Due to this linear contact, which essentially runs perpendicular to the middle axis of the coolant/lubricant supply duct, the distributor screw 1 rests straightly in the cutting tool 2, while the distributor screw is prevented from tilting. As a result, the outlet gap between the distributor head 40 and face 2S of the cutting tool 2 is uniformly large all around, so that the coolant is distributed radially uniformly in all directions. Alternatively, the coolant can be additionally guided by radial grooves corresponding to the grooves 101 from prior art, which is not shown here. In this case, the outlet gap can be reduced in size by comparison to the previously described embodiment, or the distributor screw can rest flatly on the surface between the grooves.

In principle, it is also possible to provide a flat surface instead of the inner or outer cone. In such a case, however, production tolerances may cause the distributor screw 2 to tilt in the thread 210, as a result of which the outlet gap may not remain uniformly large over its entire periphery. Other shapes are also conceivable for the end of the distributor screw 1 and transition between the bore 200 and coolant/lubricant supply duct; for example, one of the surfaces could be semispherical, paraboloid or hyperboloid. It is only crucial that the distributor screw 1 be prevented from tilting relative to the cutting tool 2 to the greatest extent possible.

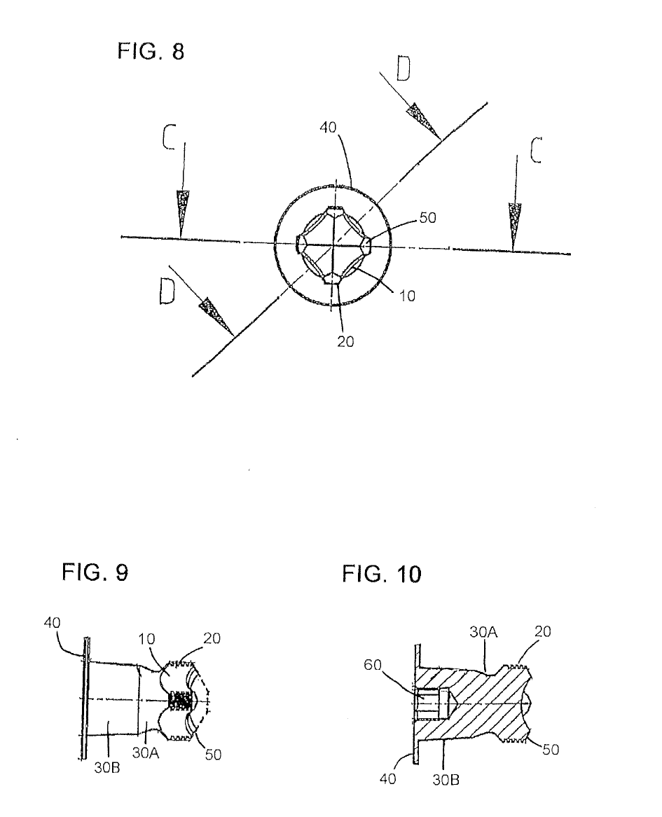

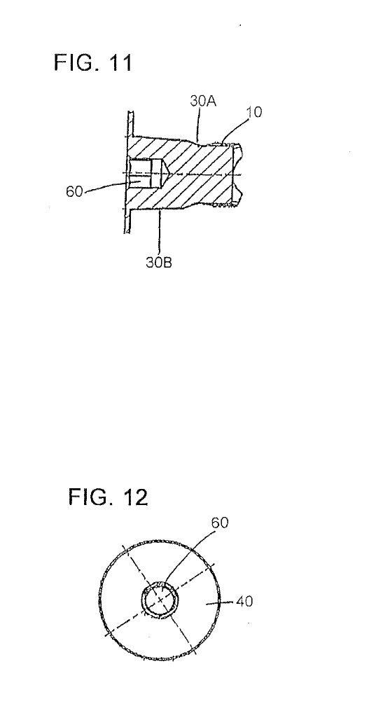

FIG. 8 presents a top view of the distributor screw according to the preferred embodiment of the invention, which records the section C-C shown on FIG. 10 and the section D-D shown on FIG. 11. In the installed state, the coolant on this figure, viewed in the direction of the observer, impinges on the distribution screw 1, which is screwed into the cutting tool 2 via the flight lands 20, and passes by the flight lands 20 and into the annular space via the axial grooves 10. As evident from FIG. 8, the axial grooves in this example are slightly curved; however, conventional flat sections can also be used, in principle. Among other things, the advantage to the gently curved shape depicted here is that the through surface for the coolant becomes larger as the flight land stays the same size, making it possible to improve coolant supply.

As also evident from FIG. 8, the distributor head 40 exhibits a distinctly larger diameter, e.g., approximately 1.5 to 2 times the diameter of the bore 200. As a result, the bore 200 is covered by the distributor head 40 like a mushroom or umbrella, and the coolant can be radially diverted along the bottom side of the distributor head 40 in the direction toward the outside of the cutting tool 2, where it exits the outlet gap formed between the distributor head 40 and face 2S of the cutting tool 2 uniformly over its entire periphery.

FIG. 9 presents a side view of the distributor screw according to the preferred embodiment of the invention. Apart from the axial grooves 10, thread sections 20 and outer cones 50 already discussed based on the figures described above, in particular the flow section 30 is clearly discernible on FIG. 9. As evident from FIG. 9, the thread section 20 with the axial grooves 10 is in this embodiment of the distributor screw 1 followed by a torically constricted shank section 30A, which passes over into a conically expanding shank section 30B. As already explained, it is significant for the invention that an annular space be provided in the assembled state, which allows the coolant to become uniformly distributed. However, the embodiment shown here also allows the coolant to depressurize in the space between the bore 200 and shank section 30A, and to again accelerate while continuing to flow through the tapering annular space formed by the bore 200 and shank section 30B, thereby giving it the chance in particular to become uniformly distributed over the entire periphery of the annular space. The coolant then hits the distributor head 40, and is diverted uniformly in all directions, in order to exit the outlet gap between the face 2S of the cutting tool and the bottom side of the distributor head 40 uniformly in all directions. As already explained, the radially flat face 2S of the cutting tool shown here in conjunction with the also flat bottom side of the distributor head 40 yields an outlet gap that is largely uniform, so that the flow rate of the coolant essentially does not change all that much anymore after the diversion. Even though this is not shown, the distributor head 40 and face 2S can interact in such a way that the distance between the distributor head 40 and face 2S does not remain constant, but rather either gets larger or smaller toward the outlet gap if the bottom side of the distributor head is fabricated in such a way as not to be parallel to the face 2S. As a result, the flow of coolant can be further optimized as needed, for example if space considerations do not allow the fabrication of a long enough annular space. For example, tapering the annular space up until the diversion and then expanding it up until the outlet gap can result in an acceleration of an aerosol flow, similarly to a Laval nozzle. Even if the bottom side of the distributor head is not parallel to the face 2S, the distributor head can cover the face, e.g., like a mushroom or umbrella.

FIG. 10 presents a section C-C through the distributor screw 1 shown on FIG. 8. In addition to the outer contour already discussed based on FIG. 9, FIG. 10 reveals a screw drive in the form of a hexagon socket, which can be used to screw in the distributor screw 1. Similarly, FIG. 11 also presents a section D-D through the distributor screw shown on FIG. 8 at an angle of 45° relative to the section from FIG. 10. Also evident from FIGS. 10 and 11 is that a spherical trough is provided on the face of the distributor screw. Even though the screw could in principle also form a smooth seal, fabricating the spherical surface on the screw closure optimizes the transfer of the coolant, which exits the coolant/lubricant supply duct 220 into the axial grooves 10. This reduces the flow resistance, and hence the necessary coolant delivery rate at a given coolant quantity.

FIG. 12 presents a top view of the screw drive of the distributor screw according to the preferred embodiment of the invention, i.e., a top view of the distributor screw from the side lying opposite the top view from FIG. 8. As already explained above, the screw drive in the present embodiment is a hexagon socket. Alternatively, however, use can be made of any screw drive desired, such as a hexagon head, a slot, spax or torx drive. If (not shown here) no thread is provided, a connection can be established between the distributor and cutting tool 2 by way of press fitting, soldering or adhesive bonding, as already mentioned, as long as an annular space and an outlet gap are created as described above.

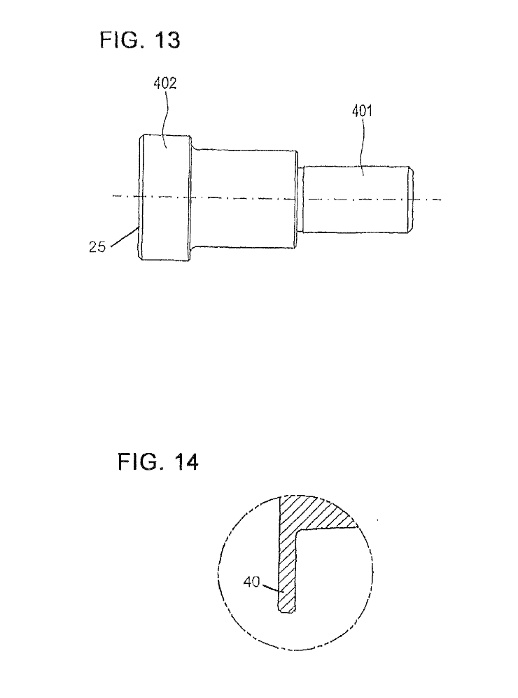

FIG. 13 presents a schematic side view of a reamer as an example for a cutting tool according to the invention. As readily evident from a comparison with the sectioned cutting tool from FIG. 2 according to prior art, no grooves that distribute the coolant have been milled into the cutting tool according to the invention. The face of the cutting tool can be flat instead. A distributor screw is screwed into the cutting tool as explained above, so that coolant is conveyed toward the machining surface 402. Similarly to the tool shank 104 from prior art as described with respect to FIG. 1, the tool shank 401 is used for clamping the cutting tool.

FIG. 14 presents a detail of the distributor screw shown on FIG. 6. More precisely, FIG. 14 depicts the transition between the distributor head 40 and shank section 30B of the distributor screw 1, which in conjunction with the bore 220 forms the annular space. Let it be noted that the transition between the shank section 30B and distributor head 40 should be designed with as large a radius as possible so as to allow a favorable flow. On the other hand, however, too large a radius can result in space problems, since the space in the bore 220 into which the radius must fit is naturally limited.

In summary, the invention provides the following:

A distributor screw 1 and cutting device 2 are created that form an annular space between a shank 30 of the distributor screw 1 and a bore 220, into which the distributor screw 1 is introduced. Coolant/lubricant supplied from a central coolant/lubricant supply duct via axial grooves 10 is uniformly distributed in the annular space, so as to be radially diverted in all directions at a distributor head 40 of the distributor screw 1, i.e., over 360°, and uniformly discharged in the direction of the cutting blades or surfaces.

### REFERENCE LIST

1 Distributor screw
2 Cutting tool
2S Face of the cutting tool
10 Axial groove
20 Flight land
30 Shank
30A, 30B Shank sections
40 Distributor head
50 Outer cone
60 Screw drive
101 Groove (prior art)
102 Free surface (prior art)
103, 104 Shank sections (prior art)
105 Cutting edge (prior art)
200 Bore
210 Thread section
220 Coolant supply duct
230 Inner cone
401 Tool shank
402 Cutting surface
501 Cooling duct with large diameter (SdT)
502 Coolant/lubricant supply duct
503 Groove (prior art)
1001 Screw head (prior art)
1002, 1005 Leveled area of screw head
1003 Step (prior art)
1004 Screw shank (prior art)
1301, 1401 Distributor head (prior art)
1302,1404,1305,1406 Leveled area of screw head
1303, 1405 Screw drive (prior art)
1403 Thread (prior art)
1404 Screw shank (prior art)

1. A cutting tool mounted for rotary drive, comprising:
a shank part,
a cutting part, the cutting part comprising a plurality of cutting edges,
a coolant and/or lubricant supply duct that runs centrally along a rotational axis at least in an end section of the cutting part remote from the shank part, and exits on a face of the cutting part remote from the shank part, and
a distributor screw comprising a thread shank that is screwed into the coolant and/or lubricant supply duct and that comprises a plurality of flight lands spaced apart from each other in a peripheral direction by axial grooves, and a head that diverts coolant and/or lubricant flowing in axially via the coolant and/or lubricant supply duct and axial grooves radially in the direction of the cutting edges,
the distributor screw comprising a flow section that has a cross section with a lower diameter in a flowing direction of the coolant and/or lubricant in the area between the flight lands and the head, and forms an axially extending annular space all around the flow section with a thread bore in the cutting part.

2. The cutting tool mounted for rotary drive according to claim 1, wherein the annular space is cylindrical.

3. The cutting tool mounted for rotary drive according to claim 1, wherein the annular space tapers in the flowing direction of the coolant/lubricant.

4. The cutting tool mounted for rotary drive according to claim 3, wherein the annular space tapers at an angle of 1° to 5°, opposite the axial direction in the flowing direction.

5. The cutting tool mounted for rotary drive according to claim 1, wherein the distributor screw is attached in the coolant and/or lubricant supply duct in such a way that the head of the distributor screw is a predefined distance from a face end of the coolant and/or lubricant supply duct.

6. The cutting tool mounted for rotary drive according to claim 1, wherein a side of the distributor screw remote from the head exhibits an outer cone, which abuts against an inner core formed in front of a threaded section in the flowing direction in order to center and fix an axial position of the distributor screw relative to the cutting part of the cutting tool.

7. The cutting tool mounted for rotary drive according to claim 1, wherein a flow surface on a back side of the head of the distributor screw lies at a defined axial distance to the face of the cutting part.

8. The cutting tool mounted for rotary drive according to claim 1,
wherein the head of the distributor screw is flat on a side facing the coolant and/or lubricant supply duct in the installed state.

9. The cutting tool mounted for rotary drive according to claim 1, wherein a surface of the cutting part lying opposite the head of the distributor screw is flat in the installed state.

10. The cutting tool mounted for rotary drive according to claim 1, wherein at least either the head of the distributor screw or a surface of the cutting part lying opposite the head of the distributor screw in the installed state encompasses at least one coolant and/or lubricant supply groove.

11. The cutting tool mounted for rotary drive according to claim 1, wherein the head comprises a screw drive.

12. The cutting tool mounted for rotary drive according to claim 3, wherein the annular space tapers at an angle of 3°, opposite the axial direction in the flowing direction.

13. The cutting tool mounted for rotary drive according to claim 1, wherein the head comprises a hexagon socket or a hexagon head.
